(19) United States
(12) Patent Application Publication
(10) Pub. No.: US 2007/0230404 A1
(43) Pub. Date: Oct. 4, 2007

(54) Method of Controlling Power in a Cdma-2000 System

(76) Inventor: Tae Ik Song, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/568,234

(22) PCT Filed: Sep. 24, 2004
(86) PCT No.: PCT/KR04/02469

§ 371 Date: Mar. 8, 2007

(30) Foreign Application Priority Data
Sep. 30, 2003 (KR) 10-2003-0067736

(51) Int. Cl. H04B 7/216

(52) U.S. Cl. 370/335

(57) ABSTRACT

The present invention is directed to a method of controlling power in a CDMA-2000 system. In a conventional CDMA-2000 system, a reverse-link power control algorithm has been employed, which is optimized only for voice communication. The purpose of the reverse-link power control for voice communication is to maintain the error rate of the frame received in the reverse channel below a certain rate (typically, an error rate 1%). As such, the reverse-link power control algorithm for voice communication is not suitable for a data service, the throughput of which needs to be maximized. Based on the above observation, the present invention suggests a method of implementing different algorithms according to the service type to be provided through a CDMA-2000 system. That is, if the service type is a voice service, the conventional reverse-link power control algorithm that is used for an IS-95A or IS-95B CDMA system is employed at a Base Station Subsystem (BTS). However, if the service type is a data service, a target Energy per Bit/Noise Total (Eb/Nt) value for each of a reverse fundamental channel and a reverse supplemental channel is determined based on the statuses of the frames received in the reverse channels. With the suggested method, the present invention can optimize the power control algorithm for both the voice service and the data service. Thus, the throughput in the data service can be enhanced.

### TECHNICAL FIELD

The present invention generally relates to a method of controlling power in a CDMA-2000 system, and more particularly to a method of controlling power of an external circuit and a lock-out circuit for a reverse-link data service in a CDMA-2000 system in consideration of both a reverse fundamental channel and a supplemental channel.

### BACKGROUND ART

Generally, a CDMA system uses a power control method for enhancing voice quality and increasing the capacity of the system. To this end, the conventions mobile communication system has provided only a voice-oriented service. It was optimized for maximizing the voice quality.

An IS-95A or IS-95B CDMA system employs various reverse-link power control methods and is optimized for a voice communication service. Further, a low-rate data service provided by the IS-95A or IS-95B system is based on the voice communication service. As such, the system performance and the link performance are not affected even when the IS-95A or IS-95B system is optimized only for the voice communication service.

Therefore, at a Base station Transceiver Subsystem (BTS), the conventions reverse-link power control algorithm determines a power control bit according to the status of a reception frame in a reverse fundamental channel. Also, the mobile unit adjusts its transmission power by receiving the power control bit.

Further, a CDMA-2000 1x system and a CDMA-2000 3x system provide both the conventional voice service and a high-rate data service. In such systems, a fast power control method for a lock-out circuit is supplemented for providing the high-rate data service in a forward link.

However, in a reverse link, the conventional power control method for voice communication has been employed in case a supplemental channel was added to a reverse link. This was in order to provide the high-rate data service.

In case of employing the conventional power control algorithm for a reverse link, which has been used for a voice service when performing a data service in a CDMA-2000 system, the following problems may occur.

First, the purpose of reverse-link power control is to satisfy a certain voice quality criterion for a voice service, and to further maximize and maintain the throughput of the system for a data service. Therefore, for a data service, the reverse-link power control should be performed in a manner that the reception Frame Error Rate (FER) is maintained below a certain rate (generally, 1%). On the other hand, the FER may be changed so as to maximize the throughput of the system for a data service. Thus, in case of using the conventional reverse-link power control algorithm and parameter values therefor, the FER has been maintained below 1% for a data service. However, the throughput of the system could not be maximized.

Next, a reverse-link data service in a CDMA-2000 1x system is performed through a supplemental channel, while a signaling message is transmitted through a fundamental channel. However, the conventional reverse-link power control method considered only the fundamental channel and adjusted the transmission power of a supplemental channel according to the power of the fundamental channel. This method is disadvantageous in that consideration of both a fundamental channel and a supplemental channel is needed for a data service.

In this respect, the conventional reverse-link power control method optimized for a voice service is not suitable for a data service. This is because it degrades the system performance and the service quality.

### DISCLOSURE OF INVENTION

Technical Problem

It is, therefore, an object of the present invention to address and resolve the above disadvantage associated with the conventional reverse-link power control method.

It is another object of the present invention to design a power control algorithm for an external circuit and a lock-out circuit to be optimized for a data service, and to further perform power control of two channels with one power control bit. In particular, when the conventional voice service is provided, the conventional reverse-link power control method is performed. On the other hand, when a data service is provided, a reverse-link power control algorithm in accordance with the present invention is performed. With the present invention, a power control algorithm optimized for both the voice service and the data service can be performed. This provides enhanced reverse-link performance of a data service in CDMA-2000 1x and 3x systems. This also provides a method for controlling power of an external circuit and a lock-out circuit for a data service in a CDMA-2000 system.

Technical Solution

In order to achieve the above objects, a method of controlling power in a CDMA-2000 system in accordance with the present invention comprises the following steps: selecting a service type to be provided; if the selected service type is a data service, implementing a reverse-link power control algorithm for the data service; if the selected service type is a voice service, implementing a reverse-link power control algorithm for an IS-95A or IS-95B CDMA system; and determining a target Energy per Bit/Noise Total (Eb/Nt) value.

Further, in order to achieve the above objects, the reverse-link power control algorithm for a data service comprises the steps of: at a Base station Transceiver Subsystem (BTS), checking the statuses of reception frames through a fundamental channel and a supplemental channel; determining a target Eb/Nt value for each of the fundamental and supplemental channels; transmitting the determined target Eb/Nt value from a Base Station Controller (BSC) to the BTS; at the BTS, checking a current Eb/Nt value for each of the fundamental and supplemental channels between power control groups; comparing the current Eb/NT value with the transmitted target Eb/Nt value; determining power control bits for the fundamental and supplemental channels; and at the BTS, transmitting the determined power control bits to a mobile unit in turn.

### ADVANTAGEOUS EFFECTS

According to the features of the present invention, (1) by performing the conventional reverse-link power control method when the conventional voice service is provided, and (2) by performing a reverse-link power control algorithm in accordance with the present invention when a data service is provided, a power control algorithm optimizable for the voice service and the data service can be performed.

Further, by considering both a fundamental channel and a supplemental channel for providing power control for a reverse-link data service in a CDMA-2000 system, enhanced reverse-link performance and a higher rate of the data service in CDMA-2000 1x and 3x systems can be achieved.

Moreover, the present invention improves the throughput and the data transmission rate of a data service by designing a power control algorithm for a data service.

Lastly, the present invention can be directly adapted to the conventional CDMA-2000 system without incurring additional costs.

### BRIEF DESCRIPTION OF THE DRAWINGS

These drawings depict only the preferred embodiments of the present invention and should not be considered as limitations of its scope. These as well as other features of the present invention will become more apparent upon reference to the drawings in which:

FIG. 1 illustrates a process in accordance with the present invention for selecting a reverse-link power control algorithm according to service types.

FIG. 2 illustrates a reverse-link power control process of an external circuit for a data service according to the present invention.

FIG. 3 illustrates a reverse-link power control process of a lock-out circuit for a data service according to the present invention.

### BEST MODE FOR CARRYING OUT THE INVENTION

Hereinafter, preferred embodiments of the present invention will be described and illustrated with reference to the accompanying drawings.

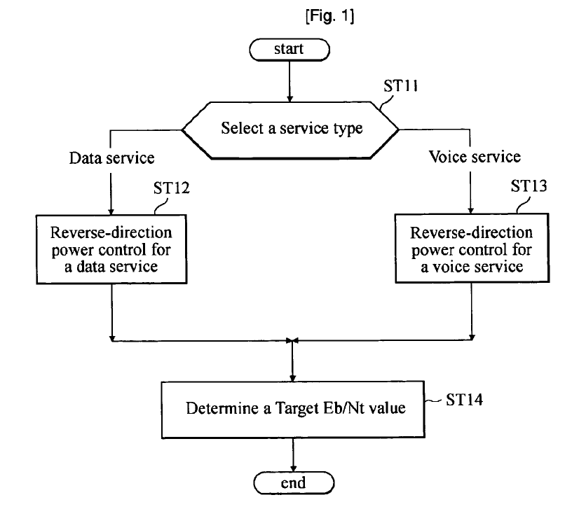

FIG. 1 illustrates a process in accordance with the present invention for selecting a reverse-link power control algorithm according to service types. As shown in FIG. 1, the process comprises the steps of: (1) selecting a service type to be provided (ST11); if the selected service type is a data service, implementing a reverse-link power control algorithm for the data service (ST12); if the selected service type is a voice service, implementing a reverse-link power control algorithm that is used for an IS-95A or IS-95B CDMA system (ST13); and after implementing one of the above power control algorithms, determining a target Energy per Bit/Noise Total (Eb/Nt) value (ST14).

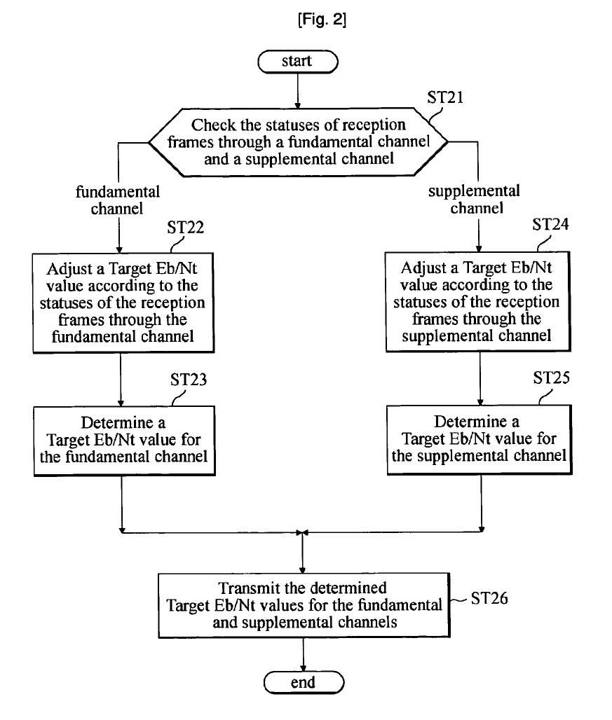

FIG. 2 illustrates a reverse-link power control process of an external circuit for a data service according to the present invention. As shown in FIG. 2, the process comprises the steps of: checking at a BTS the statuses of reception frames through a fundamental channel and a supplemental channel (ST21); adjusting a target Eb/Nt value according to the statuses of the reception frames through the fundamental channel (ST22); determining a target Eb/Nt value for the fundamental channel (ST23); adjusting a target Eb/Nt value according to the statuses of the reception frames through the supplemental channel (ST24); determining a target Eb/Nt value for the supplemental channel (ST25); and transmitting the determined target Eb/Nt values for the fundamental and supplemental channels from a BSC to the BTS (ST26).

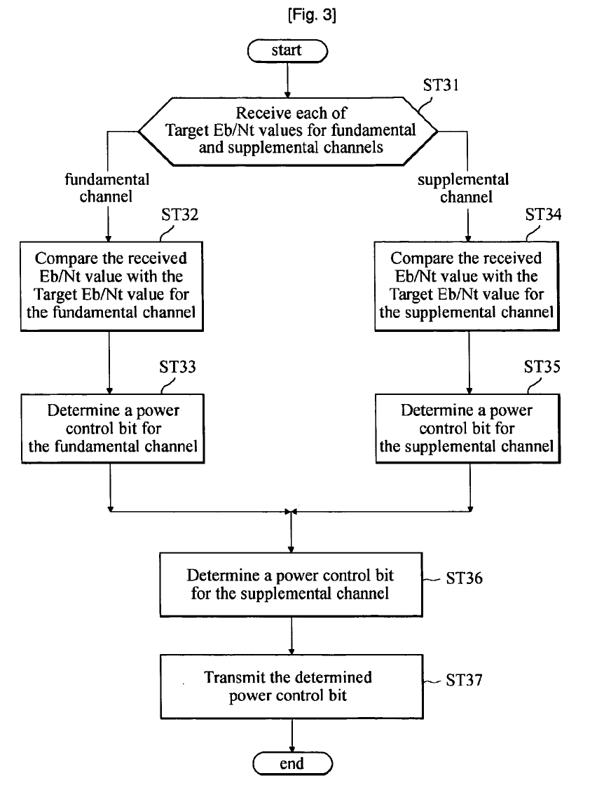

FIG. 3 illustrates a reverse-link power control process of a lock-out circuit for a data service according to the present invention. As shown in FIG. 3, the process comprises the steps of: receiving a target Eb/Nt value for each of fundamental and supplemental channels from a BSC to a BTS (ST31); checking at the BTS the received Eb/Nt values between power control groups to compare the Eb/Nt value received from the BSC with the target Eb/Nt value for the fundamental channel (ST32); determining a power control bit for the fundamental channel (ST33); comparing the Eb/Nt value received from the BSC with the target Eb/Nt value for the supplemental channel (ST34); determining a power control bit for the supplemental channel (ST35); selecting the power control bit for the fundamental channel or the supplemental channel (ST36); and transmitting the determined power control bit (ST37).

Hereinafter, processes in FIGS. 1-3 will be explained in detail.

First, as shown in FIG. 1, two individual algorithms are implemented according to service types. In other words, a reverse-link power control algorithm generally used in an IS-95A or IS-95B system is implemented for a voice service, while the newly invented reverse-link power control algorithm is implemented for a data service.

With reference to FIGS. 2 and 3, the reverse-link power control algorithm for a data service will be explained in detail.

When a reverse-link data service is implemented, reverse fundamental and supplemental channels are used together. Therefore, a BTS checks the statuses of reception frames for the channels. According to the statuses of reception frames, target Eb/Nt values for the channels are adjusted.

For a voice service, only a fundamental channel is used. Thus, it is sufficient to adjust one target Eb/Nt value. However, when both of the channels are used for a data service, then each of the target Eb/Nt values needs to be adjusted for the channels.

Upon determining a target Eb/Nt value for each of the fundamental and supplemental channels, a BSC transmits the determined values to a BTS. The BTS receives the target Eb/Nt values for the fundamental and supplemental channels. After that, the BTS checks the Eb/NT values for the fundamental and supplemental channels between power control groups (1.25 ms), and compares the Eb/Nt values with the target Eb/Nt values received from the BSC. Lastly, each of power control bits for the channels is decided.

Since only one power control bit can be transmitted to a mobile unit according to the standard of the conventional CDMA system, the BTS transmits the power control bits in turn. In other words, by alternately transmitting one of the two power control bits, each of which is decided for either the fundamental channel and/or the supplemental channel, the power control for the fundamental and supplemental channels is performed with one power control bit.

The mobile unit adjusts its transmission power using the power control bit transmitted from the BTS. Upon adjusting the transmission power, the power for the fundamental channel, as well as the power for the supplemental channel, becomes adjusted.

Therefore, two channels can be adjusted according to the power ratio defined by the IS-2000 standard. This means that power control of a lock-out circuit can be performed for both of the two channels. As such, the power ratio may be selected according to channel environments and priority of a service to be provided. Further, the latter implies that it is possible to select a larger power ratio for the supplemental channel for a data service.

Additional modifications and improvements of the present invention may also be apparent to those of ordinary skill in the art. Thus, the particular descriptions herein is intended to represent only certain embodiments of the present invention, and is not intended to serve as imitations of an alternative allocation method within the scope of the invention.

1. A method of controlling power in a CDMA-2000 system, said method comprising the steps of:
selecting a service type to be provided;
if the selected service type is a data service, implementing a reverse-link power control algorithm for the data service;
if the selected service type is a voice service, implementing a reverse-link power control algorithm for an IS-95A or IS-95B CDMA system; and
determining a target Energy per Bit/Noise Total (Eb/Nt) value.

2. The method as claimed in claim 1, wherein said reverse-link power control algorithm for a data service comprises the steps of:
at a Base station Transceiver Subsystem (BTS), checking the statuses of reception frames through a fundamental channel and a supplemental channel;
determining a target Eb/Nt value for each of the fundamental and supplemental channels;
transmitting the determined target Eb/Nt value from a Base Station Controller (BSC) to the BTS;
at the BTS, checking a current Eb/Nt value for each of the fundamental and supplemental channels between power control groups;
comparing the current Eb/NT value with the transmitted target Eb/Nt value;
determining power control bits for the fundamental and supplemental channels; and
at the BTS, transmitting the determined power control bits to a mobile unit in turn.
